(19) United States
(12) Patent Application Publication
(10) Pub. No.: US 2022/0142194 A1
(43) Pub. Date: May 12, 2022

(54) A VEGETABLE FAT COMPOSITION COMPRISING C14 FATTY ACIDS

(71) Applicant: AAK AB (PUBL), Malmö (SE)

(72) Inventors: Morten Daugaard ANDERSEN, Højbjerg (DK); Anne BRINKØ, Viby J (DK)

(21) Appl. No.: 17/433,391

(22) PCT Filed: Feb. 28, 2020
(86) PCT No.: PCT/EP2020/055303

§ 371 Date: Aug. 24, 2021

(30) Foreign Application Priority Data
Mar. 1, 2019 (SE) 1950266-5
Jul. 1, 2019 (SE) 1950827-4

(51) Int. Cl. A23D 9/02; A23G 1/38

(52) U.S. Cl. CPC A23D 9/02; A23G 1/38

(57) ABSTRACT

Disclosed is a vegetable fat composition comprising at least two different triglycerides comprising fatty acids selected from saturated fatty acids and unsaturated fatty acids, wherein at least one of the triglycerides comprises C14-fatty acids. Additionally disclosed is a method of producing such a vegetable fat composition in addition to various uses of such a composition. A vegetable fat composition as disclosed has some of the properties from cocoa butter substitute and some of the properties from cocoa butter replacer, combined in one product, in addition to being a cost effective vegetable fat composition.

### TECHNICAL FIELD OF THE INVENTION

The present invention relates to a vegetable fat composition comprising different triglycerides with at least one of the triglycerides comprising C14-fatty acids. The invention also relates to uses of the vegetable fat composition in bakery, dairy, or confectionary applications or in chocolate or chocolate-like coating, as well as a method of producing said vegetable fat composition.

### BACKGROUND OF THE INVENTION

The main dietary source of industrial trans-unsaturated fatty acids are partially hydrogenated vegetable oils. The World Health Organization argues that the removal of partially hydrogenated vegetable oils from the food supply would result in substantial health benefits.

After determining in June 2015 that partially hydrogenated oils (PHOs) were no longer ‘generally recognized as safe’ for use in human food, the United States Food and Drug Administration requested food manufacturers to remove them from products by June 2018.

The European Union does not currently have legislation regulating the content of trans-unsaturated fatty acids in food products or requiring their labelling. Thus, should a product contain partially hydrogenated oils (and hence, possibly trans-unsaturated fatty acids), its label will indicate this, but it will not indicate the exact amount of trans-unsaturated fatty acids present in said product.

However, more and more EU Member States are setting legal limits on industrially produced trans-unsaturated fatty acids in foods and there has been growing pressure to establish this as an EU-wide practice. This legislation trend about non-trans-unsaturated fatty acids is not only present in EU and US but is spreading all over the world. In Russia, from January 2018, legislation changed the safety parameter “trans-isomers of fatty acids” from 20% to 2% of the product's fat content.

Increasing global transformation from high-trans cocoa butter replacer (CBR) to low/no-trans CBR due to legislations will be a big challenge for confectionery producers of high-trans CBR, especially to limit/eliminate trans containing applications while maintaining the good properties of such products.

Moreover, the customers who already switched from a high-trans CBR to a low-trans CBR solution seems not to be fully satisfied with the different solutions from fat and oil producers.

Using high-trans CBR has the advantages of a short setting time, high gloss, high cocoa butter (CB) tolerance, and a non-lauric product (i.e. the fatty acids do not contain lauric acid), while it has the obvious disadvantage of a high trans-unsaturated fatty acids content.

Using low-trans (or non-trans) CBR has the advantages of a low to no content trans-unsaturated fatty acids and it contains a similar saturated fatty acid (SAFA) content compared to CB, while it has the disadvantages of a longer setting time, a less glossy end product, lower cocoa butter tolerance, and a poorer meltdown, all compared to high-trans CBR.

Using high-end cocoa butter substitute (CBS) has the advantages of a very short setting time, a high gloss in the end product, and a good meltdown, while having the disadvantages of a low CB tolerance, a high amount of SAFA of 90 wt. % or more, a potential risk of soapy off flavor if the process on the compound line is poorly controlled due to a relatively high amount of lauric fatty acids (C12:0), and a poor flexibility to interchange CBR and CBS products on the same compound line due to risk of contaminating a CBR product with a CBS product.

For the above reasons, vegetable oil producers are currently finding themselves in the quest for a product which can combine the best functions from the CBS (e.g. fast setting time and high gloss) with the attractive functionality from the CBR (e.g. no risk for soapy taste, lower SAFA content, and possibly maintaining a clean label (i.e. low to no content trans-unsaturated fatty acids)).

Accordingly, the main object of the invention is to provide a vegetable fat product, which can combine the best functions from the CBS with the attractive functionality from the CBR.

Another object is to provide a vegetable fat product with a low risk of soapy off flavor and a comparable price, said vegetable fat product is in the form of a vegetable fat composition comprising at least two different triglycerides.

Yet another object is to provide a number of applications for such fats compositions.

### SUMMARY OF THE INVENTION

The present invention relates to a vegetable fat composition comprising at least two different triglycerides, wherein the triglycerides comprise fatty acids selected from saturated (S) fatty acids and unsaturated (U) fatty acids, and at least one of the triglycerides comprises C14-fatty acids, and wherein the vegetable fat composition comprises between 3% and 97% by weight of C14-fatty acids compared to the total weight of fatty acids, wherein the ratio of the weight of C14-fatty acids to the total weight of C8-, C10-, C12-, and C14-fatty acids in the vegetable fat composition is between 0.40 and 1.00, and wherein the vegetable fat composition is not selected from nutmeg oil.

The vegetable fat composition of the present invention has, combined in one product, some of the properties from CBS, such as fast crystallization speed and high gloss; some of the properties from CBR, such as no or a low risk of soapy taste due to a relatively low content of lauric acid (C12:0) and lower molecular weight fatty acids (e.g. C10 and C8). Additionally, a vegetable fat composition as disclosed is also a cost effective vegetable fat composition with at least a comparable price compared to product on the market today.

The present invention also relates to a cocoa butter replacer (CBR) comprising the vegetable fat composition.

The present invention further relates to a method for production of the vegetable fat composition, wherein the method comprises the steps of:
a) mixing glycerol and fatty acids, wherein the fatty acids is comprising between 3% and 97% by weight of C14, in a reaction container comprising a vacuum inlet, hereby obtaining a first glycerol and fatty acids mixture;
b) heating the first glycerol and fatty acids mixture to at least 140° C. under reduced pressure over a predefined amount of time;
c) keeping the first glycerol and fatty acids mixture at the temperature of step b) for a predefined amount of time, hereby obtaining a second glycerol and fatty acids mixture;
d) heating the second glycerol and fatty acids mixture to at least 180° C. over a predefined amount of time;
e) keeping the second glycerol and fatty acids mixture at the temperature of step d) for a predefined amount of time, hereby obtaining a crude vegetable fat composition;
f) optionally bleaching and filtering the crude vegetable fat composition; and
g) optionally removal of unreacted excess free fatty acids from the crude vegetable fat composition by distillation at a temperature of at least 160° C., optionally under reduced pressure, to obtain the final vegetable fat composition comprising triglycerides.

A reaction container may be any container suitable for carrying out a chemical reaction. Such containers may e.g. be, but not limited to, a flask, a tank, a tube, an Erlenmeyer flask, a laboratory flask, a round-bottom flask, a three-necked flask, a two-necked flask, a one-necked flask, a PCR tube, a glass flask, a metal flask, or an Eppendorf tube.

Use of the vegetable fat composition for bakery, dairy, or confectionary applications; or in coating or enrobing for bakery or confectionary applications; or for chocolate or chocolate-like coating is also disclosed herein.

Further is the use of the vegetable fat composition in fillings, such as bakery fillings and confectionary fillings; or for the manufacture of a processed food product; or as a fat component, which are to be incorporated in a food product also disclosed herein.

Further is the use of the vegetable fat composition for chocolate or chocolate-like spreads, which are spreadable at room temperature.

The invention also relates to a confectionary or chocolate or chocolate-like product comprising between 10 wt. % and 70 wt. %, such as between 20 wt. % and 65 wt. %, such as between 25 wt. % and 40 wt. %, by weight of the vegetable fat composition of the invention.

### Definitions

As used herein, the term “vegetable” shall be understood as originating from a plant or a single cell organism. Thus, vegetable fat or vegetable triglycerides are still to be understood as vegetable fat or vegetable triglycerides if all the fatty acids used to obtain said triglyceride or fat is of plant or single cell organism origin.

S means a saturated fatty acid, and U means an unsaturated fatty acid. The fatty acids, which are comprised in the triglycerides of formulae SSU, SUS, etc. and referred to in the SSU/SUS ratio, may be identical or different, saturated and unsaturated fatty acids.

Saturated fatty acids are chains of carbon atoms joined by single bonds, with the maximum number of hydrogen atoms attached to each carbon atom in the chain. Unsaturated fatty acids are chains of carbon atoms joined by single bonds and varying numbers of double bonds, which do not have their full quota of hydrogen atoms attached. An unsaturated acid can exist in two forms, the cis form and the trans form. A double bond may exhibit one of two possible configurations: trans or cis. In trans configuration (a trans fatty acid), the carbon chain extends from opposite sides of the double bond, whereas, in cis configuration (a cis fatty acid), the carbon chain extends from the same side of the double bond. The trans fatty acid is a straighter molecule. The cis fatty acid is a bent molecule.

By using the nomenclature CX means that the fatty acid comprises X carbon atoms, e.g. a C14 fatty acid has 14 carbon atoms while a C8 fatty acid has 8 carbon atoms.

By using the nomenclature CX:Y means that the fatty acid comprises X carbon atoms and Y double bonds, e.g. a C14:0 fatty acid has 14 carbon atoms and 0 double bonds while a C18:1 fatty acid has 18 carbon atoms and 1 double bond.

A ratio of the weight of C14-fatty acids to the total weight of C8-, C10-, C12-, and C14-fatty acids means that the weight of C14-fatty acids is divided by the sum of C8-, C10-, C12-, and C14-fatty acids (C14/C8+C10+C12+C14)

As used herein, “%” or “percentage” relates to weight percentage i.e. wt. % or wt.-% if nothing else is indicated.

As used herein, “vegetable oil” and “vegetable fat” are used interchangeably, unless otherwise specified.

As used herein the term “single cell oil” shall mean oil from oleaginous microorganisms which are species of yeasts, molds (fungal), bacteria and microalgae. These single cell oils are produced intracellular and in most cases during the stationary growth phase under specific growth conditions (e.g. under nitrogen limitation with simultaneous excess of a carbon source). Examples of oleaginous microorganisms are, but not limited to, Mortierella alpineea, Yarrowia lipolytica, Schizochytrium, Nannochloropsis, Chlorella, Crypthecodinium cohnii, Shewanella.

As used herein “cocoa butter replacer” is intended to mean an edible fat having a triglyceride composition significantly different to cocoa butter. Cocoa butter replacers can have from high to low and even no trans fatty acids in its triglyceride composition. Cocoa butter replacers are only mixable with cocoa butter in medium to small ratios. Furthermore, in contrast to chocolate, cocoa butter replacer based compounds do not need to undergo a treatment at different temperatures, known as tempering, prior to molding, coating, or enrobing, in order to obtain a final product with acceptable shelf life.

As used herein “edible” is something that is suitable for use as food or as part of a food product, such as a dairy or confectionary product.

For products and methods in the confectionery areas, reference is made to “Chocolate, Cocoa and Confectionery”, B. W. Minifie, Aspen Publishers Inc., 3. Edition 1999.

A food product is a product for human consumption. An important group of products is those where cocoa butter and cocoa butter-like fats are used.

By a chocolate or chocolate-like product is meant a product, which at least is experienced by the consumer as chocolate or as a confectionery product having sensorial attributes common with chocolate, such as e.g. melting profile, taste etc. Some chocolate comprises cocoa butter, typically in substantial amounts, where some chocolate-like product may be produced with a low amount of or even without cocoa butter, e.g. by replacing the cocoa butter with a cocoa butter equivalent, cocoa butter substitute, etc. In addition, many chocolate or chocolate-like products comprise cocoa powder or cocoa mass, although some chocolate or chocolate-like products, such as typical white chocolates, may be produced without cocoa powder, but e.g. drawing its chocolate taste from cocoa butter. Depending on the country and/or region there may be various restrictions on which products may be marketed as chocolate.

The term “comprising” or “to comprise” is to be interpreted as specifying the presence of the stated parts, steps, features, or components, but does not exclude the presence of one of more additional parts, steps, features, or components.

As used herein, the term “and/or” is intended to mean the combined (“and”) and the exclusive (“or”) use, i.e. “A and/or B” is intended to mean “A alone, or B alone, or A and B together”. For example, in the context “a cold trap and/or a condenser” it is thus intended to mean “a reaction container further comprising a cold trap”, “a the reaction container further comprising a condenser” or “a the reaction container further comprising a cold trap and a condenser”.

### DETAILED DESCRIPTION OF THE INVENTION

When describing the below embodiments, the present invention envisages all possible combinations and permutations of the below described embodiments with the above disclosed aspects.

The invention relates to a vegetable fat composition, wherein the ratio of the weight of C14-fatty acids to the total weight of C8-, C10-, C12-, and C14-fatty acids in the vegetable fat composition is between 0.40 and 1.00, the use of the vegetable fat composition, and a method for production of the vegetable fat composition.

In one or more embodiments, the ratio of the weight of C14-fatty acids to the total weight of C8-, C10-, C12-, and C14-fatty acids in the vegetable fat composition is between 0.50 and 1.00.

In one or more embodiments, the ratio of the weight of C14-fatty acids to the total weight of C8-, C10-, C12-, and C14-fatty acids in the vegetable fat composition is between 0.60 and 1.00.

In one or more embodiments, the ratio of the weight of C14-fatty acids to the total weight of C8-, C10-, C12-, and C14-fatty acids in the vegetable fat composition is between 0.70 and 1.00.

In one or more embodiments, the ratio of the weight of C14-fatty acids to the total weight of C8-, C10-, C12-, and C14-fatty acids in the vegetable fat composition is between 0.80 and 1.00.

In any of the above embodiments, the ratio of SSU to SUS in the triglycerides may be between 0.2 and 6.0 wherein SSU is an asymmetrical di-saturated triglyceride comprising two saturated fatty acids and one unsaturated fatty acid in an asymmetrical isomer, and wherein SUS is a symmetrical di-saturated triglyceride comprising two saturated fatty acids and one unsaturated fatty acid in a symmetrical isomer.

The SSU/SUS ratio may be measured/calculated in the vegetable composition. A ratio of SSU to SUS means that the weight of SSU-triglycerides is divided by the weight of SUS-triglycerides (SSU/SUS), where S means a saturated fatty acid, and U means an unsaturated fatty acid. SSU is an asymmetrical di-saturated triglyceride in which a saturated fatty acid occupies the sn1 and sn2 positions, and an unsaturated fatty acid occupies the sn3 position; or a saturated fatty acid occupies the sn2 and sn3 positions, and an unsaturated fatty acid occupies the sn1 position. SUS is a symmetrical di-saturated triglyceride in which a saturated fatty acid occupies the sn1 and sn3 positions, and an unsaturated fatty acid occupies the sn2 position.

Sn1/Sn2/Sn3:

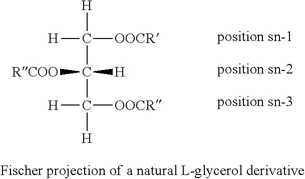

In general, triglycerides use a “sn” notation, which stands for stereospecific numbering. In a Fischer projection of a natural L-glycerol derivative, the secondary hydroxyl group is shown to the left of C-2; the carbon atom above this then becomes C-1 and that below becomes C-3. The prefix ‘sn’ is placed before the stem name of the compound.

In one or more embodiments, the ratio of SSU to SUS in the triglycerides is between 0.2 and 5.0.

In one or more embodiments, the ratio of SSU to SUS in the triglycerides is between 0.2 and 4.0.

In one or more embodiments, the ratio of SSU to SUS in the triglycerides is between 0.2 and 3.0.

In one or more embodiments, the ratio of SSU to SUS in the triglycerides is between 0.5 and 3.0.

In one or more embodiments, the ratio of SSU to SUS in the triglycerides is between 0.5 and 2.5.

In one or more embodiments, the ratio of SSU to SUS in the triglycerides is between 1.0 and 2.5.

In one or more embodiments, the ratio of SSU to SUS in the triglycerides is between 1.5 and 2.5.

In one or more embodiments, the triglycerides comprise at least 20 wt. % saturated fatty acids.

By at least 20 wt. % saturated fatty acids is meant that at least 20% of the total weight of fatty acids in the triglycerides is from saturated fatty acids.

In one or more embodiments, the triglycerides comprise at least 25 wt. % saturated fatty acids.

In one or more embodiments, the triglycerides comprise between 35 wt. % and 90 wt. % saturated fatty acids.

In one or more embodiments, the triglycerides comprise between 55 wt. % and 85 wt. % saturated fatty acids.

In one or more embodiments, the triglycerides comprise between 60 wt. % and 80 wt. % saturated fatty acids.

In one or more embodiments, the triglycerides comprise saturated fatty acids comparable to cocoa butter.

By comparable to cocoa butter is meant that the saturated fatty acid level in the vegetable fat composition is similar to the saturated fatty acid level found in cocoa butter.

In one or more embodiments, the vegetable fat composition is not originating from a single cell organism.

In one or more embodiments, the vegetable fat composition comprises 10 wt. % or less C12-fatty acid.

In one or more embodiments, the vegetable fat composition comprises 5 wt. % or less C12-fatty acid.

In one or more embodiments, the vegetable fat composition comprises 1 wt. % or less C12-fatty acid.

In one or more embodiments, the vegetable fat composition is essentially free of C12-fatty acid.

By essentially free is meant that the composition comprises 1 wt. % or less, such as almost totally free of C12-fatty acids.

All non-lauric products existing on the market at the present time results in a reduction in capacity when compared to a high trans CBR product. An alternative product to a high trans CBR may be a CBS product, however, the increased risk for CBS products to give a soapy taste in the end product due to poor handling/processing at the compound producer may be a deterrent for some producers to use a CBS product instead of a high trans CBR product.

In one or more embodiments, the triglycerides comprise 15 wt. % or less trans-unsaturated fatty acids.

In one or more embodiments, the triglycerides comprise 10 wt. % or less trans-unsaturated fatty acids.

In one or more embodiments, the triglycerides comprise 5 wt. % or less trans-unsaturated fatty acids.

In one or more embodiments, the triglycerides comprise 2 wt. % or less trans-unsaturated fatty acids.

In one or more embodiments, the triglycerides comprise 1 wt. % or less trans-unsaturated fatty acids.

In one or more embodiments, the vegetable fat composition is a non-hydrogenated vegetable fat composition.

Hydrogenation is a process where unsaturated fatty acids are made partially saturated. Non-hydrogenated means not hydrogenated or un-hydrogenated. By subjecting unsaturated fatty acids to a process of hydrogenation (e.g. involving a combination of catalysts, hydrogen, and heat), the double bond opens, and hydrogen atoms bind to the carbon atoms, hereby saturating the double bond. While most of the unsaturated oil will either remain as was (on its double bond structure) or be converted to the corresponding saturated fatty acid, some of the double bonds may open during the hydrogenation process and then re-close in another double bond configuration, hereby converting a cis fatty acid to a trans fatty acid or vice versa. A non-hydrogenated vegetable fat composition is a composition comprising only non-hydrogenated fatty acids, meaning that the process of hydrogenation has not been performed on the fatty acids in said composition.

The vegetable fat composition, which is a non-hydrogenated vegetable fat composition, is a vegetable fat composition, which maintains a clean label while still obtaining the properties from CBS and some of the properties from CBR.

In one or more embodiments, the C14-fatty acids are saturated fatty acids (C14:0). A C14:0 fatty acid is also known as myristic acid.

In one or more embodiments, the vegetable fat composition comprises between 3% and 95% by weight of C14-fatty acids compared to the total weight of fatty acids.

In one or more embodiments, the vegetable fat composition comprises between 5% and 95% by weight of C14-fatty acids compared to the total weight of fatty acids.

In one or more embodiments, the vegetable fat composition comprises between 5% and 90% by weight of C14-fatty acids compared to the total weight of fatty acids.

In one or more embodiments, the vegetable fat composition comprises between 5% and 80% by weight of C14-fatty acids compared to the total weight of fatty acids.

In one or more embodiments, the vegetable fat composition comprises between 7% and 80% by weight of C14-fatty acids compared to the total weight of fatty acids.

In one or more embodiments, the vegetable fat composition comprises between 10% and 35% by weight of C14-fatty acids compared to the total weight of fatty acids.

In one or more embodiments, the vegetable fat composition comprises between 10% and 25% by weight of C14-fatty acids compared to the total weight of fatty acids.

In one or more embodiments, the triglycerides comprise at least 5 wt. % unsaturated fatty acids.

By at least 5 wt. % unsaturated fatty acids is meant that at least 5% of the total weight of fatty acids in the triglycerides is from unsaturated fatty acids.

In one or more embodiments, the triglycerides comprise 80 wt. % or less unsaturated fatty acids.

In one or more embodiments, the triglycerides comprise 75 wt. % or less unsaturated fatty acids.

In one or more embodiments, the triglycerides comprise between 10 wt. % and 65 wt. % unsaturated fatty acids.

In one or more embodiments, the triglycerides comprise between 15 wt. % and 45 wt. % unsaturated fatty acids.

In one or more embodiments, the triglycerides comprise between 20 wt. % and 40 wt. % unsaturated fatty acids.

In one or more embodiments, the triglycerides comprise at least 1 wt. % C16-fatty acids, selected from C16:0 (palmitic acid), C16:1 (palmitoleic acid), or combinations hereof.

By at least 1 wt. % C16-fatty acids is meant that at least 1% of the total weight of fatty acids in the triglycerides is from C16-fatty acids, wherein the C16-fatty acids are selected from palmitic acid, palmitoleic acid, or combinations hereof.

In one or more embodiments, the triglycerides comprise at least 5 wt. % C16-fatty acids selected from C16:0 (palmitic acid), C16:1 (palmitoleic acid), or combinations hereof.

In one or more embodiments, the triglycerides comprise at least 5 wt. % C18-fatty acids, selected from C18:0 (stearic acid), C18:1 (oleic acid), C18:2 (linoleic acid), or combinations hereof.

By at least 5 wt. % C18-fatty acids is meant that at least 5% of the total weight of fatty acids in the triglycerides is from C18-fatty acids, wherein the C18-fatty acids are selected from stearic acid, oleic acid, linoleic acid, or combinations hereof.

In one or more embodiments, the triglycerides comprise at least 10 wt. % C18-fatty acids selected from C18:0 (stearic acid), C18:1 (oleic acid), C18:2 (linoleic acid), or combinations hereof.

In one or more embodiments, the vegetable fat composition is for use in bakery, dairy, or confectionary applications.

In one or more embodiments, the bakery or confectionary application is selected from biscuit, cake, muffin, donut, pastry, or bread applications.

In one or more embodiments, the vegetable fat composition is for use in molding, coating, enrobing, or filling chocolate or chocolate-like applications.

The vegetable fat composition may be used as fillings, such as bakery fillings and confectionary fillings.

In one or more embodiments, the vegetable fat composition is for use as a chocolate or chocolate-like coating.

In one or more embodiments of the present method, the optional step f) of bleaching and filtering the crude vegetable fat composition is performed before the optional step g) of removal of unreacted excess free fatty acids from the crude vegetable fat composition by distillation at a temperature of at least 160° C., optionally under reduced pressure.

In one or more embodiments of the present method, the optional step g) of removal of unreacted excess free fatty acids from the crude vegetable fat composition by distillation at a temperature of at least 160° C., optionally under reduced pressure, is performed before the optional step 0 of bleaching and filtering the crude vegetable fat composition.

In one or more embodiments of the present method, the method comprises the steps of:
a) mixing glycerol and fatty acids, wherein the fatty acids is comprising between 3% and 97% by weight of C14, in a reaction container comprising a vacuum inlet, hereby obtaining a first glycerol and fatty acids mixture;
b) heating the first glycerol and fatty acids mixture to at least 140° C. under reduced pressure over a predefined amount of time;
c) keeping the first glycerol and fatty acids mixture at the temperature of step b) for a predefined amount of time, hereby obtaining a second glycerol and fatty acids mixture;
d) heating the second glycerol and fatty acids mixture to at least 180° C. over a predefined amount of time;
e) keeping the second glycerol and fatty acids mixture at the temperature of step d) for a predefined amount of time, hereby obtaining a crude vegetable fat composition;
f) bleaching and filtering the crude vegetable fat composition, to obtain the final vegetable fat composition comprising triglycerides.

In one or more embodiments of the present method, the method comprises the steps of:
a) mixing glycerol and fatty acids, wherein the fatty acids is comprising between 3% and 97% by weight of C14, in a reaction container comprising a vacuum inlet, hereby obtaining a first glycerol and fatty acids mixture;
b) heating the first glycerol and fatty acids mixture to at least 140° C. under reduced pressure over a predefined amount of time;
c) keeping the first glycerol and fatty acids mixture at the temperature of step b) for a predefined amount of time, hereby obtaining a second glycerol and fatty acids mixture;
d) heating the second glycerol and fatty acids mixture to at least 180° C. over a predefined amount of time;
e) keeping the second glycerol and fatty acids mixture at the temperature of step d) for a predefined amount of time, hereby obtaining a crude vegetable fat composition;
f) removal of unreacted excess free fatty acids from the crude vegetable fat composition by distillation at a temperature of at least 160° C., optionally under reduced pressure, to obtain the final vegetable fat composition comprising triglycerides.

In one or more embodiments of the present method, the method comprises the steps of:
a) mixing glycerol and fatty acids, wherein the fatty acids is comprising between 3% and 97% by weight of C14, in a reaction container comprising a vacuum inlet, hereby obtaining a first glycerol and fatty acids mixture;
b) heating the first glycerol and fatty acids mixture to at least 140° C. under reduced pressure over a predefined amount of time;
c) keeping the first glycerol and fatty acids mixture at the temperature of step b) for a predefined amount of time, hereby obtaining a second glycerol and fatty acids mixture;
d) heating the second glycerol and fatty acids mixture to at least 180° C. over a predefined amount of time;
e) keeping the second glycerol and fatty acids mixture at the temperature of step d) for a predefined amount of time, hereby obtaining a crude vegetable fat composition;
f) removal of unreacted excess free fatty acids from the crude vegetable fat composition by distillation at a temperature of at least 160° C., optionally under reduced pressure; and
g) bleaching and filtering the crude vegetable fat composition, to obtain the final vegetable fat composition comprising triglycerides.

In one or more embodiments of the present method, the method comprises the steps of:
a) mixing glycerol and fatty acids, wherein the fatty acids is comprising between 3% and 97% by weight of C14, in a reaction container comprising a vacuum inlet, hereby obtaining a first glycerol and fatty acids mixture;
b) heating the first glycerol and fatty acids mixture to at least 140° C. under reduced pressure over a predefined amount of time;
c) keeping the first glycerol and fatty acids mixture at the temperature of step b) for a predefined amount of time, hereby obtaining a second glycerol and fatty acids mixture;
d) heating the second glycerol and fatty acids mixture to at least 180° C. over a predefined amount of time;
e) keeping the second glycerol and fatty acids mixture at the temperature of step d) for a predefined amount of time, hereby obtaining a crude vegetable fat composition;
f) bleaching and filtering the crude vegetable fat composition; and
g) removal of unreacted excess free fatty acids from the crude vegetable fat composition by distillation at a temperature of at least 160° C., optionally under reduced pressure, to obtain the final vegetable fat composition comprising triglycerides.

In one or more embodiments of the present method, the second glycerol and fatty acid mixture in step d) is heated to at least 190° C. over a predefined amount of time, such as at least 200° C., such as at least 210° C., or such as at least 220° C. over a predefined amount of time.

In one or more embodiments of the present method, the second glycerol and fatty acid mixture in step d) is heated to at least 230° C. over a predefined amount of time, such as at least 240° C., or such as at least 250° C. over a predefined amount of time.

In one or more embodiments of the present method, the second glycerol and fatty acid mixture in step d) is heated to a temperature between 180 and 250° C. over a predefined amount of time, such as between 190 and 250° C., such as between 200 and 240° C., or such as between 210 and 230° C. over a predefined amount of time.

In one or more embodiments of the present method, the reduced pressure of step b) is a pressure below 600 mbar, such as below 400 mbar, such as below 200 mbar, such as below 100 mbar, such as below 50 mbar, such as a pressure below 40 mbar.

In one or more embodiments of the present method, the reaction container further comprises a cold trap and/or a condenser heated to at least 40° C., such as at least 50° C.

In one or more embodiments of the present method, the predefined amount of time of step b) is at least 10 minutes, such as at least 20 minutes, such as at least 30 minutes.

In one or more embodiments of the present method, the predefined amount of time of step c) is at least 10 minutes, such as at least 20 minutes, such as at least 30 minutes.

In one or more embodiments of the present method, the predefined amount of time of step d) is at least 1 hour, such as at least 2 hours.

In one or more embodiments of the present method, the predefined amount of time of step e) is at least 2 hours, such as at least 4 hours, such as at least 6 hours, such as at least 8 hours, such as at least 10 hours, such as at least 12 hours, such as at least 14 hours.

In one or more embodiments of the present method, a catalyst is added in step a). The addition of a catalyst may increase reaction speed and hence reduce the overall reaction time needed to obtain the crude vegetable fat composition. The catalyst can be any catalyst known to be beneficial in an esterification process and particularly preferred is the use of zinc oxide as a catalyst. Hence, in one or more embodiments of the present method, zinc oxide (ZnO) is added in step a) as a catalyst.

As it is known to the person skilled in the art, the predefined amount of time in step e) needed for keeping the second glycerol and fatty acid mixture at the temperature of step d) for obtaining a crude vegetable fat composition will decrease if a catalyst is used. If a catalyst is used the predefined amount of time of step e) is at least 1 hour, such as at least 2 hours, such as at least 3 hours, such as at least 4 hours, such as at least 5 hours.

In one or more embodiments of the present method, zinc oxide (ZnO) is added in step a) as a catalyst and the predefined amount of time of step e) is at least 1 hour, such as at least 2 hours, such as at least 3 hours, such as at least 4 hours, such as at least 5 hours.

It is well within the skills of the skilled person to determine the amount of catalyst needed in the method. In one or more embodiments of the present method, that amount of catalyst added is at least 0.8‰, such as at least 0.9‰, such as 1‰. The skilled person will also know that a higher amount of catalyst can be added, which will lead to a faster reaction time, however there is a natural upper limit of how much catalyst there should be added. In one or more embodiments of the present method, no more than 2% catalyst is added, such as no more than 1%, such as no more than 0.5%.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisage all possible combinations and permutations of the described embodiments.

The present invention is further illustrated by the following examples, which are not to be construed as limiting the scope of protection.

### EXAMPLES

### Example 1—Esterification of Glycerol with Free Fatty Acids

Glycerol and fatty acids were mixed to provide the reaction mixtures given in table 1. Each reaction mixture was then placed in a 6 L three-necked flask, equipped with a vacuum inlet, a cold trap, and a condenser heated to 50° C. The reaction mixture was heated to 160° C. over 30 min under reduced pressure of 33 mbar. The reaction mixture was kept at 160° C. for 30 min, before the temperature was raised to 210° C. over a 2-hour period. Once the final reaction temperature was reached, the reaction mixture was left for 15 hours. The crude oil may be obtained by bleaching and filtering before excess free fatty acids is distilled of at 240° C. under reduced pressure to yield the final product. However, in this example the crude oil obtained was removed of excess free fatty acids by distillation at 240° C. under reduced pressure, and then bleached and filtered, to yield the final product as shown in table 1. Table 1 displays the feed composition and the fatty acid composition of the triglyceride (TAG) products.

TABLE 1
Feed composition and FAC on TAG products.

| Vegetable TAG Product | A | B | C | D | E | F |
|---|---|---|---|---|---|---|
| Glycerol (g) | 87.0 | 88.5 | 90.0 | 88.3 | 88.4 | 90.0 |
| Glycerol (mol) | 0.95 | 0.96 | 0.98 | 0.96 | 0.96 | 0.98 |
| 99% Lauric acid (g) | — | — | — | — | 344.4 | — |
| 99% Lauric acid (mol) | — | — | — | — | 1.72 | — |
| 99% Myristic acid (g) | 622.5 | 789.0 | 943.5 | 537.9 | 394.6 | 1077.1 |
| 99% Myristic acid (mol) | 2.73 | 3.45 | 4.13 | 2.35 | 1.73 | 4.72 |
| 98% Palmitic acid (g) | 436.5 | 265.5 | 105.0 | — | 265.3 | — |
| 98% Palmitic acid (mol) | 1.70 | 1.04 | 0.41 | — | 1.04 | — |
| 98% Stearic acid (g) | — | — | — | 670.0 | — | — |
| 98% Stearic acid (mol) | — | — | — | 2.36 | — | — |
| 82% Oleic acid (g) | 352.5 | 357.0 | 361.5 | 292.1 | 357.1 | 332.8 |
| 82% Oleic acid (mol) | 1.25 | 1.26 | 1.28 | 1.04 | 1.26 | 1.18 |
| Composition Product | | | | | | |
| FFA | 0.7 | 0.9 | 0.7 | 0.8 | 1.0 | 1.0 |
| MAG | <0.1 | <0.1 | <0.1 | <0.1 | <0.1 | <0.1 |
| DAG | 0.3 | 0.5 | 1.1 | 0.8 | 0.7 | 0.9 |
| TAG | 95.2 | 94.8 | 94.6 | 94.9 | 94.4 | 94.2 |
| Fatty acid composition of TAG | | | | | | |
| product | | | | | | |
| C12:0 (% w/w) | 0.0 | 0.0 | 0.0 | 0.0 | 29.8 | 0.0 |
| C14:0 (% w/w) | 47.9 | 59.8 | 70.7 | 34.8 | 30.0 | 77.6 |
| C16:0 (% w/w) | 30.1 | 18.3 | 7.4 | 0.8 | 18.2 | 0.5 |
| C18:0 (% w/w) | 0.5 | 0.5 | 0.4 | 45.7 | 0.6 | 0.4 |
| C18:1 (% w/w) | 18.1 | 18.1 | 18.1 | 15.9 | 18.1 | 18.1 |
| C18:2 (% w/w) | 2.7 | 2.7 | 2.7 | 2.0 | 2.7 | 2.7 |
| C20:1 (% w/w) | 0.1 | 0.1 | 0.1 | 0.0 | 0.1 | 0.1 |
| Other fatty acids (% w/w) | 0.6 | 0.5 | 0.6 | 0.8 | 0.5 | 0.6 |
| SAFA (% w/w) | 78.7 | 78.6 | 78.6 | 81.5 | 78.7 | 78.6 |
| Ratio C14/(C8 + C10 + C12 + C14) | 1.00 | 1.00 | 1.00 | 1.00 | 0.50 | 1.00 |
| TAG composition of TAG product | | | | | | |
| SSS | 49.3 | 49.3 | 49.3 | 55.1 | 49.3 | 49.3 |
| SSU | 26.2 | 26.2 | 26.2 | 24.2 | 26.2 | 26.2 |
| SUS | 13.1 | 13.1 | 13.1 | 12.1 | 13.1 | 13.1 |
| SUU | 7.0 | 7.0 | 7.0 | 5.3 | 7.0 | 7.0 |
| USU | 3.5 | 3.5 | 3.6 | 2.7 | 3.5 | 3.5 |
| UUU | 0.9 | 0.9 | 0.9 | 0.6 | 0.9 | 0.9 |
| SSU/SUS | 2.0 | 2.0 | 2.0 | 2.0 | 2.0 | 2.0 |

Table 1 displays the composition of the TAG products produced in example 1, which all have high TAG contents (94-95%) and low free fatty acid (FFA), mono-glyceride (MAG), and di-glyceride (DAG) contents, respectively. This is highly beneficial as this means that the obtained TAG product is of high purity with very few contaminants to be removed. The fatty acid composition of the TAG part of the product has myristic contents between 30 and 78 wt. %. Furthermore, the SAFA contents are 78-82 wt. %. The TAG composition of the TAG products displays a randomized distribution of the fatty acids on the glycerol as also observed for the fatty acid distribution of vegetable oils after chemical inter-esterification.

The composition product is analyzed using AOCS Cd 22-91. The fatty acid composition of TAG product is analyzed using IUPAC 2.301 (Methylation) and IUPAC 2.304 (GLC). The TAG composition of the TAG product is calculated using the proviso of 100% random chemical inter-esterification.

### Example 2—Recipes and Manufacture of Milk and Dark Chocolate-Like Compounds

Table 2 displays the recipes for a dark chocolate compound used.

TABLE 2
Composition of dark chocolate-like compound

| | |
|---|---|
| Vegetable fat (% w/w) | 30.0 |
| Cocoa powder (10-12% CB) (% w/w) | 15.0 |
| Sugar (% w/w) | 48.6 |
| Skim milk powder (% w/w) | 6.0 |
| Lecithin | 0.4 |
| Total fat content (% w/w) | 31.7 |
| The fat composition distribution in the recipe | |
| Vegetable fat (%) | 94.6 |
| Cocoa butter (%) | 5.2 |
| Milk fat (%) | 0.2 |

### Example 3—Crystallization Speed and Gloss for Samples 3A, 3B, 3C, 3D, 3E, 3F, Ref 1, Ref 2, and Ref 3

Dark compounds with recipe given in table 2 based on vegetable fat of TAG products A, B, C, D, E, and F from example 1 are produced. Furthermore, three commercially available reference compounds from AAK-AB are produced as well. Reference 1 is partly Lauric cocoa butter replacer (CBR) compound with the trade name AKOPOL™ NH 30, reference 2 is a low trans CBR with trade name AKOPOL™ LT 03, and reference 3 is a high trans CBR with trade name AKOPOL™ MC 80.

All the ingredients for the dark compounds were mixed in a Hobart N-50 mixer at 65° C. for ten minutes and refined in a Bühler SDY-300 three-roll refiner to a particle size of approximately 20μ. Thereafter, the dark compounds were conched in the Hobart mixer for 6 hours at 65° C.

Gloss Evaluation of Dark Compound Coating on Biscuits

Biscuits were coated with the dark compound coatings described herein above in example 2 at 45° C. in a Nielsen enrobing machine followed by cooling in a three-zone cooling tunnel at temperatures of 6° C., 6° C. and 15° C. for 15 minutes. The gloss was evaluated by visual inspection after 1 week of storage at 20° C. The number of “+” indicate the gloss on a scale from “1+” to “4+”, where a higher number denotes a higher gloss. “1+” is a dull surface whereas “4+” is a high glossy compound surface.

Crystallization Speed for Dark Compound Coating on Biscuits

Biscuits were coated with the dark compound coatings from example 2 at 45° C. in a Nielsen enrobing machine followed by cooling in a three-zone cooling tunnel at temperatures of 6° C., 6° C. and 15° C. The dark compound coatings on the biscuits are subjectively evaluated at specific cooling times and the coating is evaluated via the following score scale:
1. The coating is still liquid on some parts of the biscuit, while other parts are semi solidified.
2. The whole coating is semi solidified, but very sticky and very soft. There is no liquid coating parts on biscuit anymore.
3. The whole coating has solidified, however, the coating is still sticky, soft, and not ready for packaging.
4. The whole coating is hard and not sticky. It is possibly to pack the product but the coating is still not completely solidified.

The score value of 4 is the most important score as it indicates that the coated biscuits are ready for flow packing.

Results from crystallization speed test and gloss for compound coatings of biscuits are illustrated in table 3.

TABLE 3
Dark compound recipe, crystallization speed, and variations in gloss.

| Dark compounds | 3A | 3B | 3C | 3D | 3E | 3F | Ref 1 | Ref 2 | Ref 3 |
|---|---|---|---|---|---|---|---|---|---|
| Vegetable fat composition | A | B | C | D | E | F | Ref 1 | Ref 2 | Ref 3 |

Crystallization speed

| | | | | | | | | | |
|---|---|---|---|---|---|---|---|---|---|
| 60 sec | 3 | 3 | 3 | 4 | 3 | 3 | | | 1 |
| 75 sec | 4 | 4 | 4 | | 4 | 4 | 3 | 1 | 1 |
| 100 sec | | | | | | | 4 | 3 | 1 |
| 120 sec | | | | | | | | | 3 |
| 200 sec | | | | | | | | 3 | 4 |
| 300 sec | | | | | | | | 4 | |

Gloss of compound coating on biscuit

| | | | | | | | | | |
|---|---|---|---|---|---|---|---|---|---|
| Gloss scale | 4+ | 4+ | 4+ | 4+ | 4+ | 4+ | 4+ | 2+ | 3+ |

The five dark compounds 3A, 3B, 3C, 3E, and 3F display very fast crystallization speed in which a coating value of 4 were obtained after 75 seconds. Compound 3D is even faster with a coating value of 4 obtained after 60 seconds. This is slightly faster as compared to the partly Lauric CBR (ref. 1) and significantly faster than both the low trans CBR (ref. 2) and high trans CBR (ref. 3) compounds. Furthermore, the degree of gloss of the six compounds is as high as the partly lauric CBR (ref. 1) and significantly glossier than both the low trans CBR (ref. 2) and high trans CBR (ref. 3) compounds.

### Example 4—Fat Blends for Example 5

The A, B, C, D, and E TAG products of example 1 are blended with a mid-fraction from an inter-esterified blend of palm and shea fractions (vegetable fat blend M). Table 4 displays the oil blend compositions.

TABLE 4
Vegetable oil blend compositions.

| | Al | B1 | Cl | D1 | E1 | A2 | B2 | C2 | D2 | E2 | M |
|---|---|---|---|---|---|---|---|---|---|---|---|
| TAG product A/% | 50 | | | | | 25 | | | | | |
| TAG product B/% | | 50 | | | | | 25 | | | | |
| TAG product C/% | | | 50 | | | | | 25 | | | |
| TAG product D/% | | | | 50 | | | | | 25 | | |
| TAG product E/% | | | | | 50 | | | | | 25 | |
| Mid-fraction of RX | 50 | 50 | 50 | 50 | 50 | 75 | 75 | 75 | 75 | 75 | 100 |
| palm and | | | | | | | | | | | |
| shea fractions blend/% | | | | | | | | | | | |

Fatty acid composition of oil blend product

| | | | | | | | | | | | |
|---|---|---|---|---|---|---|---|---|---|---|---|
| C12:0 (% w/w) | 0.0 | 0.0 | 0.0 | 0.0 | 14.9 | 0.0 | 0.0 | 0.0 | 0.0 | 7.5 | 0.0 |
| C14:0 (% w/w) | 24.5 | 30.5 | 35.9 | 18.0 | 15.6 | 12.8 | 15.8 | 18.5 | 9.5 | 8.3 | 1.1 |
| C16:0 (% w/w) | 42.1 | 36.2 | 30.7 | 27.4 | 36.1 | 48.0 | 45.1 | 42.4 | 40.7 | 45.1 | 54.0 |
| C18:0 (% w/w) | 5.0 | 5.0 | 5.0 | 27.6 | 5.1 | 7.3 | 7.3 | 7.3 | 18.6 | 7.3 | 9.5 |
| C18:1 (% w/w) | 23.3 | 23.3 | 23.3 | 22.2 | 23.3 | 25.8 | 25.8 | 25.8 | 25.3 | 25.8 | 28.4 |
| C18:2 (% w/w) | 4.1 | 4.1 | 4.1 | 3.7 | 4.1 | 4.7 | 4.7 | 4.7 | 4.6 | 4.7 | 5.4 |
| C20:0 (% w/w) | 0.3 | 0.3 | 0.3 | 0.3 | 0.3 | 0.5 | 0.5 | 0.5 | 0.5 | 0.5 | 0.6 |
| C20:1 (% w/w) | 0.2 | 0.2 | 0.2 | 0.1 | 0.2 | 0.2 | 0.2 | 0.2 | 0.2 | 0.2 | 0.2 |
| Other FA’s (% w/w) | 0.7 | 0.7 | 0.7 | 0.8 | 0.7 | 0.7 | 0.7 | 0.7 | 0.8 | 0.8 | 0.8 |
| SAFA (% w/w) | 72.0 | 71.9 | 71.9 | 73.4 | 72.0 | 68.6 | 68.6 | 68.6 | 69.3 | 68.6 | 65.2 |

The mid-fraction from an inter-esterified blend of palm and shea fractions (vegetable fat blend M) contains a low myristic content of 1.1 wt. %. Thus, blends of TAG products A, B, C, D, and E with the mid-fraction from an inter-esterified blend of palm and shea fractions (vegetable fat blend M) results in reduced myristic contents in the final oil blend compositions. Furthermore, a reduction in SAFA content of the blends as compared to the TAG products A, B, C, D, and E is also observed due to the lower SAFA content of vegetable fat blend M.

### Example 5—Crystallization Speed and Gloss for Samples 5A1-2, 5B1-2, 5C1-2, 5D1-2, 5E1-2, 5M, and Ref 1

Dark compounds with recipe given in Table 2 based on vegetable oils blends from example 4 are produced. The compounds are compared to a compound made with the commercially available partly lauric CBR (ref. 1). Results from crystallization speed test and gloss for compound coatings of biscuits are illustrated in table 5.

TABLE 5
Dark compound recipe, crystallization speed, and variations in gloss.

| Dark compounds | 5A1 | 5B1 | 5C1 | 5D1 | 5E1 | 5A2 | 5B2 | 5C2 | 5D2 | 5E2 | 5M | Ref 1 |
|---|---|---|---|---|---|---|---|---|---|---|---|---|
| Vegetable oil blend | Al | B1 | C1 | D1 | E1 | A2 | B2 | C2 | D2 | E2 | M | Ref 1 |

Crystallization speed

| | | | | | | | | | | | | |
|---|---|---|---|---|---|---|---|---|---|---|---|---|
| 60 sec | 2 | 2 | 2 | 3 | 2 | 2 | 2 | 2 | 2 | 2 | 1 | 3 |
| 90 sec | 4 | 4 | 4 | 4 | 4 | 2 | 2 | 2 | 3 | 2 | 2 | 4 |
| 180 sec | | | | | | 4 | 4 | 4 | 4 | 4 | 3 | |
| 240 sec | | | | | | | | | | | 3 | |
| 480 sec | | | | | | | | | | | 4 | |

Gloss of compound coating on biscuit

| | | | | | | | | | | | | |
|---|---|---|---|---|---|---|---|---|---|---|---|---|
| Gloss scale | 4+ | 4+ | 4+ | 4+ | 4+ | 3+ | 3+ | 3+ | 3+ | 3+ | 2+ | 4+ |

The addition of mid-fraction from an inter-esterified blend of palm and shea fractions (vegetable fat blend M) to the vegetable oil blends result in longer crystallization time for the compounds in the cooling tunnel to obtain a crystallization speed score of “4”. Thus, a decrease in crystallization speed is observed by addition of the mid-fraction from an inter-esterified blend of palm and shea fractions to the TAG products A, B, C, D, and E. However, the crystallization speeds for all 10 compounds 5A1, 5B1, 5C1, 5D1, 5E1, 5A2, 5B2, 5C2, 5D2, and 5E2 are still all higher than the compound 5M based on the mid-fraction from an inter-esterified blend of palm and shea fraction (vegetable fat blend M). Furthermore, the crystallization speed for compounds 5A1, 5B1, 5C1, 5D1, and 5E1 is comparable to the partly lauric CBR (ref. 1).

The degree of gloss on the finished compound coating on the biscuit decreases as a function of lower myristic containing TAG but all are glossier than compound 5M.

### Example 6—Fat Blends for Example 7

The A, B, and C TAG products of example 1 are blended with a palm mid-fraction IV 33 and/or mid-fraction from an inter-esterified blend of palm and shea fractions (vegetable fat blend M). Table 7 displays the oil blend compositions.

TABLE 6
Vegetable oil blend compositions

| Vegetable oil blend | A3 | B3 | C3 | A4 | B4 | C4 | M |
|---|---|---|---|---|---|---|---|
| TAGproduct A/% | 12.5 | | | 25 | | | |
| TAGproduct B/% | | 12.5 | | | 25 | | |
| TAGproduct C/% | | | 12.5 | | 25 | | |
| Mid-fraction of | 87.5 | 87.5 | 87.5 | 50 | 50 | 50 | 100 |
| RX palm and shea | | | | | | | |
| fractions blend/% | | | | | | | |
| Palm mid-fraction IV 33 | | | | 25 | 25 | 25 | |
| Fatty acid composition | | | | | | | |
| of TAG product | | | | | | | |
| C12:0 (% w/w) | 0.0 | 0.0 | 0.0 | 0.0 | 0.0 | 0.0 | 0.0 |
| C14:0 (% w/w) | 7.0 | 8.4 | 9.8 | 12.8 | 15.7 | 18.5 | 1.1 |
| C16:0 (% w/w) | 51.0 | 49.5 | 48.2 | 48.6 | 45.7 | 42.9 | 54.0 |
| C18:0 (% w/w) | 8.4 | 8.4 | 8.4 | 6.6 | 6.6 | 6.5 | 9.5 |
| C18:1 (% w/w) | 27.1 | 27.1 | 27.1 | 26.7 | 26.7 | 26.7 | 28.4 |
| C18:2 (% w/w) | 5.1 | 5.1 | 5.1 | 4.1 | 4.1 | 4.1 | 5.4 |
| C20:0 (% w/w) | 0.5 | 0.5 | 0.5 | 0.4 | 0.4 | 0.4 | 0.6 |
| C20:1 (% w/w) | 0.2 | 0.2 | 0.2 | 0.1 | 0.1 | 0.1 | 0.2 |
| Other FA’s (% w/w) | 0.8 | 0.8 | 0.8 | 0.7 | 0.7 | 0.7 | 0.8 |
| SAFA (% w/w) | 66.9 | 66.9 | 66.9 | 68.4 | 68.4 | 68.4 | 65.2 |

Both the mid-fraction from an inter-esterified blend of palm and shea fractions (vegetable fat blend M) and palm mid-fraction IV 33 contain low myristic contents. Thus, blends of TAG products A, B, and C with palm mid-fraction IV 33 and/or the mid-fraction from an inter-esterified blend of palm and shea fractions (vegetable fat blend M) results in reduced myristic contents in the final oil blend compositions. Furthermore, a reduction in SAFA content of the blends, as compared to the TAG products A, B, and C, are also observed due to the lower SAFA content of vegetable fat blend M and palm mid-fraction IV 33.

### Example 7—Crystallization Speed and Gloss for Samples 7A3-4, 7B3-4, 7C3-4, 5M, and Ref 2

Dark compounds with recipe given in table 2 based on vegetable oils blends from example 6 are produced. The compounds are compared to the commercially available low trans CBR (ref. 2). Results from crystallization speed test and gloss for compound coatings of biscuits are illustrated in table 7.

TABLE 7
Dark compound recipe, crystallization speed, and variations in gloss.

| Dark compounds | 7A3 | 7B3 | 7C3 | 7A4 | 7B4 | 7C4 | 5M | Ref 2 |
|---|---|---|---|---|---|---|---|---|
| Vegetable oil blend | A3 | B3 | C3 | A4 | B4 | C4 | M | Ref 2 |

Crystallization speed

| | | | | | | | | |
|---|---|---|---|---|---|---|---|---|
| 60 sec | 1 | 1 | 1 | 1 | 1 | 1 | 1 | |
| 90 sec | 1 | 1 | 1 | 1 | 1 | 1 | 1 | |
| 180 sec | 3 | 3 | 3 | 3 | 3 | 3 | 3 | |
| 240 sec | 3 | 3 | 3 | 3 | 3 | 3 | 3 | 3 |
| 300 sec | 4 | 4 | 4 | 4 | 4 | 4 | 3 | 4 |
| 480 sec | | | | | | | 4 | |

Gloss of compound coating on biscuit

| | | | | | | | | |
|---|---|---|---|---|---|---|---|---|
| Gloss scale | 2+ | 2+ | 2+ | 2+ | 2+ | 2+ | 2+ | 2+ |

The addition of palm mid-fraction IV 33 and/or mid-fraction from an inter-esterified blend of palm and shea fractions (reference vegetable fat blend M) to the vegetable oil blends result in longer crystallization time for the compounds in the cooling tunnel to obtain a crystallization speed score of “4”. Thus, a decrease in crystallization speed is observed. However, the crystallization speeds for all six compounds 7A3, 7B3, 7C3, 7A4, 7B4, and 7C4 are all higher than for the compound 5M based on the mid-fraction from an inter-esterified blend of palm and shea fraction (vegetable fat blend M). Furthermore, the crystallization speeds for the six compounds are comparable to that of the low trans CBR (ref. 2).

The degrees of gloss on the finished compound coating on the biscuits are all slightly dull (gloss scale 2+) and are comparable to the slightly dull surface of the low trans CBR coating (ref. 2).

### Example 8—Esterification of Glycerol and Free Fatty Acids and ZnO

Glycerol, fatty acids and ZnO (1.0%) were mixed to provide the reaction mixtures given in table 8. Each reaction mixture was then placed in a 6 L three-necked flask, equipped with a vacuum inlet, a cold trap, and a condenser heated to 70° C. The reaction mixture was heated to 160° C. over 30 min under reduced pressure of 33 mbar. The reaction mixture was kept at 160° C. for 30 min, before the temperature was raised to 210° C. over a 2-hour period. Once the final reaction temperature was reached, the reaction mixture was left for 5 hours. The crude oil may be obtained by bleaching and filtering before excess free fatty acids is distilled of at 240° C. under reduced pressure to yield the final product. However, in this example, the crude oil obtained was removed of excess free fatty acids by distillation at 240° C. under reduced pressure, and then bleached and filtered to yield the final product as shown in table 8. Table 8 displays the feed composition and the fatty acid composition of the triglyceride (TAG) products.

TABLE 8
Feed composition and FAC on TAG products.

| | X |
|---|---|
| Vegetable TAG Product | |
| Glycerol (g) | 85.5 |
| Glycerol (mol) | 0.93 |
| 99% Lauric acid (g) | — |
| 99% Lauric acid (mol) | — |
| 99% Myristic acid (g) | 571.7 |
| 99% Myristic acid (mol) | 2.50 |
| 98% Palmitic acid (g) | 214.7 |
| 98% Palmitic acid (mol) | 0.84 |
| 98% Stearic acid (g) | — |
| 98% Stearic acid (mol) | — |
| 82% Oleic acid (g) | 628.6 |
| 82% Oleic acid (mol) | 2.23 |
| ZnO (g) | 1.63 |
| ZnO (mol) | 0.02 |
| Composition Product | |
| FFA | 0.7 |
| MAG | <0.1 |
| DAG | 0.3 |
| TAG | 95.2 |
| Fatty acid composition of TAG product | |
| C12:0 (% w/w) | 0.0 |
| C14:0 (% w/w) | 41.8 |
| C16:0 (% w/w) | 16.1 |
| C18:0 (% w/w) | 0.9 |
| C18:1 (% w/w) | 35.3 |
| C18:2 (% w/w) | 5.0 |
| C20:1 (% w/w) | 0.2 |
| Other fatty acids (% w/w) | 0.7 |
| SAFA (% w/w) | 58.9 |
| Ratio C14/(C8 + C10 + C12 + C14) | 1.00 |
| TAG composition of TAG product | |
| SSS | 20.9 |
| SSU | 28.6 |
| SUS | 14.3 |
| SUU | 19.6 |
| USU | 9.8 |
| UUU | 6.7 |
| SSU/SUS | 2.0 |

Table 8 displays the composition of the TAG products produced in example 8, which all have high TAG contents (94-95%) and low free fatty acid (FFA), mono-glyceride (MAG), and di-glyceride (DAG) contents, respectively. This is highly beneficial as this means that the obtained TAG product is of high purity with very few contaminants to be removed. The TAG composition of the TAG products displays a randomized distribution of the fatty acids on the glycerol as also observed for the fatty acid distribution of vegetable oils after chemical inter-esterification.

The composition product is analyzed using AOCS Cd 22-91. The fatty acid composition of TAG product is analyzed using IUPAC 2.301 (Methylation) and IUPAC 2.304 (GLC). The TAG composition of the TAG product is calculated using the proviso of 100% random chemical inter-esterification.

The invention is further described in the following non-limiting items.
1. A vegetable fat composition comprising at least two different triglycerides, wherein the triglycerides comprise fatty acids selected from saturated (S) fatty acids and unsaturated (U) fatty acids, and at least one of the triglycerides comprises C14-fatty acids, and wherein the vegetable fat composition comprises between 3% and 97% by weight of C14-fatty acids compared to the total weight of fatty acids, wherein the ratio of the weight of C14-fatty acids to the total weight of C8-, C10-, C12-, and C14-fatty acids in the vegetable fat composition is between 0.40 and 1.00, and wherein the vegetable fat composition is not selected from nutmeg oil.
2. The vegetable fat composition according to item 1, wherein the ratio of the weight of C14-fatty acids to the total weight of C8-, C10-, C12-, and C14-fatty acids in the vegetable fat composition is between 0.50 and 1.00.
3. The vegetable fat composition according to any preceding items, wherein the ratio of the weight of C14-fatty acids to the total weight of C8-, C10-, C12-, and C14-fatty acids in the vegetable fat composition is between 0.60 and 1.00.
4. The vegetable fat composition according to any preceding items, wherein the ratio of the weight of C14-fatty acids to the total weight of C8-, C10-, C12-, and C14-fatty acids in the vegetable fat composition is between 0.70 and 1.00.
5. The vegetable fat composition according to any preceding items, wherein the ratio of the weight of C14-fatty acids to the total weight of C8-, C10-, C12-, and C14-fatty acids in the vegetable fat composition is between 0.80 and 1.00.
6. The vegetable fat composition according to any preceding items, wherein the ratio of SSU to SUS in the triglycerides is between 0.2 and 6.0 wherein SSU is an asymmetrical di-saturated triglyceride comprising two saturated fatty acids and one unsaturated fatty acid in an asymmetrical isomer, and wherein SUS is a symmetrical di-saturated triglyceride comprising two saturated fatty acids and one unsaturated fatty acid in a symmetrical isomer.
7. The vegetable fat composition according to any preceding items, wherein the ratio of SSU to SUS in the triglycerides is between 0.2 and 4.0.
8. The vegetable fat composition according to any preceding items, wherein the ratio of SSU to SUS in the triglycerides is between 0.2 and 4.0.
9. The vegetable fat composition according to any preceding items, wherein the ratio of SSU to SUS in the triglycerides is between 0.2 and 3.0.
10. The vegetable fat composition according to any preceding items, wherein the ratio of SSU to SUS in the triglycerides is between 0.5 and 2.5.
11. The vegetable fat composition according to any preceding items, wherein the ratio of SSU to SUS in the triglycerides is between 1.0 and 2.5.
12. The vegetable fat composition according to any preceding items, wherein the ratio of SSU to SUS in the triglycerides is between 1.5 and 2.5.
13. The vegetable fat composition according to any preceding items, wherein the triglycerides comprise at least 20 wt. % saturated fatty acids.
14. The vegetable fat composition according to any preceding items, wherein the triglycerides comprise at least 25 wt. % saturated fatty acids.
15. The vegetable fat composition according to any preceding items, wherein the triglycerides comprises between 35 wt. % and 90 wt. % saturated fatty acids.
16. The vegetable fat composition according to any preceding items, wherein the triglycerides comprises between 55 wt. % and 85 wt. % saturated fatty acids.
17. The vegetable fat composition according to any preceding items, wherein the triglycerides comprises between 60 wt. % and 80 wt. % saturated fatty acids.
18. In one or more embodiments, the triglycerides comprise saturated fatty acids comparable to cocoa butter.
19. The vegetable fat composition according to any preceding items, wherein the vegetable fat composition is not originating from a single cell organism.
20. The vegetable fat composition according to any preceding items, wherein the vegetable fat composition comprises 10 wt. % or less C12-fatty acid.
21. The vegetable fat composition according to any preceding items, wherein the vegetable fat composition comprises 5 wt. % or less C12-fatty acid.
22. The vegetable fat composition according to any preceding items, wherein the vegetable fat composition comprises 1 wt. % or less C12-fatty acid.
23. The vegetable fat composition according to any preceding items, wherein the vegetable fat composition is essentially free of C12-fatty acid.
24. The vegetable fat composition according to any preceding items, wherein the triglycerides comprise 15 wt. % or less trans-unsaturated fatty acids.
25. The vegetable fat composition according to any preceding items, wherein the triglycerides comprise 10 wt. % or less trans-unsaturated fatty acids.
26. The vegetable fat composition according to any preceding items, wherein the triglycerides comprise 5 wt. % or less trans-unsaturated fatty acids.
27. The vegetable fat composition according to any preceding items, wherein the triglycerides comprise 2 wt. % or less trans-unsaturated fatty acids.
28. The vegetable fat composition according to any preceding items, wherein the triglycerides comprise 1 wt. % or less trans-unsaturated fatty acids.
29. The vegetable fat composition according to any preceding items, wherein the vegetable fat composition is a non-hydrogenated vegetable fat composition.
30. The vegetable fat composition according to any preceding items, wherein the C14-fatty acids is saturated fatty acids (C14:0).
31. The vegetable fat composition according to any preceding items, wherein the vegetable fat composition comprise between 3% and 95% by weight of C14-fatty acids compared to the total weight of fatty acids.
32. The vegetable fat composition according to any preceding items, wherein the vegetable fat composition comprise between 5% and 95% by weight of C14-fatty acids compared to the total weight of fatty acids.
33. The vegetable fat composition according to any preceding items, wherein the vegetable fat composition comprise between 5% and 90% by weight of C14-fatty acids compared to the total weight of fatty acids.
34. The vegetable fat composition according to any preceding items, wherein the vegetable fat composition comprise between 5% and 80% by weight of C14-fatty acids compared to the total weight of fatty acids.
35. The vegetable fat composition according to any preceding items, wherein the vegetable fat composition comprise between 7% and 80% by weight of C14-fatty acids compared to the total weight of fatty acids.
36. The vegetable fat composition according to any preceding items, wherein the vegetable fat composition comprise between 10% and 35% by weight of C14-fatty acids compared to the total weight of fatty acids.
37. The vegetable fat composition according to any preceding items, wherein the vegetable fat composition comprise between 10% and 25% by weight of C14-fatty acids compared to the total weight of fatty acids.
38. The vegetable fat composition according to any preceding items, wherein the triglycerides comprise at least 5 wt. % unsaturated fatty acids.
39. The vegetable fat composition according to any preceding items, wherein the triglycerides comprise 80 wt. % or less unsaturated fatty acids.
40. The vegetable fat composition according to any preceding items, wherein the triglycerides comprise 75 wt. % or less unsaturated fatty acids.
41. The vegetable fat composition according to any preceding items, wherein the triglycerides comprises between 10 wt. % and 65 wt. % unsaturated fatty acids.
42. The vegetable fat composition according to any preceding items, wherein the triglycerides comprises between 15 wt. % and 45 wt. % unsaturated fatty acids.
43. The vegetable fat composition according to any preceding items, wherein the triglycerides comprises between 20 wt. % and 40 wt. % unsaturated fatty acids.
44. The vegetable fat composition according to any preceding items, wherein the triglycerides comprise at least 1 wt. % C16-fatty acids, selected from C16:0 (palmitic acid), C16:1 (palmitoleic acid), or combinations hereof.
45. The vegetable fat composition according to any preceding items, wherein the triglycerides comprise at least 5 wt. % C16-fatty acids selected from C16:0 (palmitic acid), C16:1 (palmitoleic acid), or combinations hereof.
46. The vegetable fat composition according to any preceding items, wherein the triglycerides comprise at least 5 wt. % C18-fatty acids, selected from C18:0 (stearic acid), C18:1 (oleic acid), C18:2 (linoleic acid), or combinations hereof.
47. The vegetable fat composition according to any preceding items, wherein the triglycerides comprise at least 10 wt. % C18-fatty acids selected from C18:0 (stearic acid), C18:1 (oleic acid), C18:2 (linoleic acid), or combinations hereof.
48. The vegetable fat composition according to any preceding items, for use in bakery, dairy, or confectionary applications.
49. The vegetable fat composition according to item 48, wherein the bakery or confectionary application is selected from biscuit, cake, muffin, donut, pastry, or bread applications.
50. The vegetable fat composition according to any of items 1-47, for use in molding, coating, enrobing, or filling chocolate or chocolate-like applications.
51. The vegetable fat composition according to any of items 1-47, for use as a chocolate or chocolate-like coating.
52. A cocoa butter replacer (CBR) comprising a vegetable fat composition according to any of items 1-47.
53. A method for production of a vegetable fat composition according to any of items 1-47, wherein the method comprises the steps of:
   a) mixing glycerol and fatty acids, wherein the fatty acids is comprising between 3% and 97% by weight of C14, in a reaction container comprising a vacuum inlet, hereby obtaining a first glycerol and fatty acids mixture;
   b) heating the first glycerol and fatty acid mixture to at least 140° C. under reduced pressure over a predefined amount of time;
   c) keeping the glycerol and fatty acid mixture at the temperature of step b) for a predefined amount of time, hereby obtaining a second glycerol and fatty acid mixture;
   d) heating the second glycerol and fatty acid mixture to at least 230° C. over a predefined amount of time;
   e) keeping the second glycerol and fatty acid mixture at the temperature of step d) for a predefined amount of time, hereby obtaining a crude vegetable fat composition;
   f) optionally bleaching and filtering the crude vegetable fat composition; and
   g) optionally removal of unreacted excess free fatty acids from the crude vegetable fat composition by distillation at a temperature of at least 160° C., optionally under reduced pressure, to obtain the final vegetable fat composition comprising triglycerides.
54. A method for production of a vegetable fat composition according to any of items 1-47, wherein the method comprises the steps of:
   a) mixing glycerol and fatty acids, wherein the fatty acids is comprising between 3% and 97% by weight of C14, in a reaction container comprising a vacuum inlet, hereby obtaining a first glycerol and fatty acids mixture;
   b) heating the first glycerol and fatty acid mixture to at least 140° C. under reduced pressure over a predefined amount of time;
   c) keeping the glycerol and fatty acid mixture at the temperature of step b) for a predefined amount of time, hereby obtaining a second glycerol and fatty acid mixture;
   d) heating the second glycerol and fatty acid mixture to at least 180° C. over a predefined amount of time;
   e) keeping the second glycerol and fatty acid mixture at the temperature of step d) for a predefined amount of time, hereby obtaining a crude vegetable fat composition;
   f) optionally bleaching and filtering the crude vegetable fat composition; and
   g) optionally removal of unreacted excess free fatty acids from the crude vegetable fat composition by distillation at a temperature of at least 160° C., optionally under reduced pressure, to obtain the final vegetable fat composition comprising triglycerides.
55. The method for production of a vegetable fat composition according to item 54, wherein the second glycerol and fatty acid mixture in step d) is heated to at least 190° C. over a predefined amount of time.
56. The method for production of a vegetable fat composition according to item 54, wherein the second glycerol and fatty acid mixture in step d) is heated to at least 200° C. over a predefined amount of time.
57. The method for production of a vegetable fat composition according to item 54, wherein the second glycerol and fatty acid mixture in step d) is heated to at least 210° C. over a predefined amount of time.
58. The method for production of a vegetable fat composition according to item 54, wherein the second glycerol and fatty acid mixture in step d) is heated to at least 220° C. over a predefined amount of time.
59. The method for production of a vegetable fat composition according to item 54, wherein the second glycerol and fatty acid mixture in step d) is heated to at least 230° C. over a predefined amount of time.
60. The method for production of a vegetable fat composition according to item 54, wherein the second glycerol and fatty acid mixture in step d) is heated to at least 240° C. over a predefined amount of time.
61. The method for production of a vegetable fat composition according to item 54, wherein the second glycerol and fatty acid mixture in step d) is heated to at least 250° C. over a predefined amount of time.
62. The method for production of a vegetable fat composition according to item 54, wherein the second glycerol and fatty acid mixture in step d) is heated to a temperature between 180 and 250° C. over a predefined amount of time.
63. The method for production of a vegetable fat composition according to item 54, wherein the second glycerol and fatty acid mixture in step d) is heated to a temperature between 190 and 250° C. over a predefined amount of time.
64. The method for production of a vegetable fat composition according to item 54, wherein the second glycerol and fatty acid mixture in step d) is heated to a temperature between 200 and 240° C. over a predefined amount of time.
65. The method for production of a vegetable fat composition according to item 54, wherein the second glycerol and fatty acid mixture in step d) is heated to a temperature between 210 and 230° C. over a predefined amount of time.
66. The method for production of a vegetable fat composition according to any of items 53-65, wherein the optional step f) is performed before the optional step g) or wherein the optional step g) is performed before the optional step f).
67. The method for production of a vegetable fat composition according to any of items 53-66, wherein the reduced pressure of step b) is a pressure below 600 mbar, such as below 400 mbar, such as below 200 mbar, such as below 100 mbar, such as below 50 mbar, such as a pressure below 40 mbar.
68. The method for production of a vegetable fat composition according to any of items 53-67, wherein the reaction container further comprises a cold trap and/or a condenser heated to at least 40° C., such as at least 50° C.
69. The method for production of a vegetable fat composition according to any of items 53-68, wherein the predefined amount of time of step b) is at least 10 minutes, such as at least 20 minutes, such as at least 30 minutes.
70. The method for production of a vegetable fat composition according to any of items 53-69, wherein the predefined amount of time of step c) is at least 10 minutes, such as at least 20 minutes, such as at least 30 minutes.
71. The method for production of a vegetable fat composition according to any of items 53-70, wherein the predefined amount of time of step d) is at least 1 hour, such as at least 2 hours.
72. The method for production of a vegetable fat composition according to any of items 53-71, wherein the predefined amount of time of step e) is at least 2 hours, such as at least 4 hours, such as at least 6 hours, such as at least 8 hours, such as at least 10 hours, such as at least 12 hours, such as at least 14 hours.
73. The method for production of a vegetable fat composition according to any of items 53-72, wherein a catalyst is added in step a).
74. The method for production of a vegetable fat composition according to any of items 53-73, wherein zinc oxide (ZnO) is added in step a) as a catalyst.
75. The method for production of a vegetable fat composition according to any of items 73-74, wherein the predefined amount of time of step e) when a catalyst is added in step a) is at least 1 hour, such as at least 2 hours, such as at least 3 hours, such as at least 4 hours, such as at least 5 hours.
76. The method for production of a vegetable fat composition according to any of items 53-75, wherein zinc oxide (ZnO) is added in step a) as a catalyst and the predefined amount of time of step e) is at least 1 hour, such as at least 2 hours, such as at least 3 hours, such as at least 4 hours, such as at least 5 hours.
77. The method for production of a vegetable fat composition according to any of items 73-76, wherein the amount of catalyst added is at least 0.8%0, such as at least 0.9%0, such as 1%0.
78. The method for production of a vegetable fat composition according to any of items 73-77, wherein no more than 2% catalyst is added, such as no more than 1%, such as no more than 0.5%.
79. Use of a vegetable fat composition according to any of items 1-47 for bakery, dairy, or confectionary applications.
80. Use of a vegetable fat composition according to any of items 1-47 in coating or enrobing for bakery or confectionary applications.
81. Use of a vegetable fat composition according to any of items 79 or 80, wherein the bakery or confectionary application is selected from biscuit, cake, muffin, donut, pastry, or bread applications.
82. Use of a vegetable fat composition according to any of items 1-47 in fillings, such as bakery fillings and confectionary fillings.
83. Use of a vegetable fat composition according to any of items 1-47 for chocolate or chocolate-like coating.
84. Use of a vegetable fat composition according to any of items 1-47 for the manufacture of a processed food product.
85. Use of a vegetable fat composition according to any of items 1-47 as a fat component, which are to be incorporated in a food product.
86. Use of a vegetable fat composition according to any of items 1-47 for chocolate or chocolate-like spreads, which are spreadable at room temperature.
87. A confectionary or chocolate or chocolate-like product comprising between 10 wt. % and 70 wt. %, such as between 20 wt. % and 65 wt. %, such as between 25 wt. % and 40 wt. %, by weight of a vegetable fat composition according to any of items 1-47.

1-86. (canceled)

87. A vegetable fat composition comprising at least two different triglycerides, wherein the triglycerides comprise fatty acids selected from saturated (S) fatty acids and unsaturated (U) fatty acids, and at least one of the triglycerides comprises C14-fatty acids, and wherein the vegetable fat composition comprises between 3% and 97% by weight of C14-fatty acids compared to the total weight of fatty acids, wherein the ratio of the weight of C14-fatty acids to the total weight of C8-, C10-, C12-, and C14-fatty acids in the vegetable fat composition is between 0.40 and 1.00, and wherein the vegetable fat composition is not selected from nutmeg oil.

88. The vegetable fat composition according to claim 87, wherein the ratio of the weight of C14-fatty acids to the total weight of C8-, C10-, C12-, and C14-fatty acids in the vegetable fat composition is between 0.50 and 1.00.

89. The vegetable fat composition according to claim 87, wherein the ratio of SSU to SUS in the triglycerides is between 0.2 and 6.0 wherein SSU is an asymmetrical desaturated triglyceride comprising two saturated fatty acids and one unsaturated fatty acid in an asymmetrical isomer, and wherein SUS is a symmetrical di-saturated triglyceride comprising two saturated fatty acids and one unsaturated fatty acid in a symmetrical isomer.

90. The vegetable fat composition according to claim 87, wherein the triglycerides comprise at least 20 wt. % saturated fatty acids.

91. The vegetable fat composition according to claim 87, wherein the triglycerides comprise between 35 wt. % and 90 wt. % saturated fatty acids.

92. The vegetable fat composition according to claim 87, wherein the triglycerides comprise saturated fatty acids comparable to cocoa butter.

93. The vegetable fat composition according to claim 87, wherein the vegetable fat composition does not originate from a single cell organism.

94. The vegetable fat composition according to claim 87, wherein the vegetable fat composition comprises 10 wt. % or less C12-fatty acid.

95. The vegetable fat composition according to claim 87, wherein the vegetable fat composition is essentially free of C12-fatty acid.

96. The vegetable fat composition according to claim 87, wherein the triglycerides comprise 15 wt. % or less trans-unsaturated fatty acids.

97. The vegetable fat composition according to claim 87, wherein the vegetable fat composition is a non-hydrogenated vegetable fat composition.

98. The vegetable fat composition according to claim 87, wherein the C14-fatty acids is saturated fatty acids (C14:0).

99. The vegetable fat composition according to claim 87, wherein the vegetable fat composition comprises between 3% and 95% by weight of C14-fatty acids compared to the total weight of fatty acids.

100. The vegetable fat composition according to claim 87, wherein the triglycerides comprise at least 5 wt. % unsaturated fatty acids.

101. The vegetable fat composition according to claim 87, wherein the triglycerides comprise 80 wt. % or less unsaturated fatty acids.

102. The vegetable fat composition according to claim 87, wherein the triglycerides comprise between 10 wt. % and 65 wt. % unsaturated fatty acids.

103. The vegetable fat composition according to claim 87, wherein the triglycerides comprise at least 1 wt. % C16-fatty acids.

104. The vegetable fat composition according to claim 87, wherein the triglycerides comprise at least 5 wt. % C18-fatty acids.

105. The vegetable fat composition according to claim 87, wherein the vegetable fat composition is used in bakery, dairy, or confectionary applications.

106. The vegetable fat composition according to claim 105, wherein the bakery or confectionary application is selected from biscuit, cake, muffin, donut, pastry, or bread applications.

107. The vegetable fat composition according to claim 87, wherein the vegetable fat composition is used for molding, coating, enrobing, or filling chocolate or chocolate-like applications.

108. The vegetable fat composition according to claim 87, wherein the vegetable fat composition is used in a chocolate or chocolate-like coating.

109. A cocoa butter replacer comprising a vegetable fat composition according to claim 87.

110. A method for production of a vegetable fat composition according to claim 87, wherein the method comprises:
a) mixing glycerol and fatty acids, wherein the fatty acids comprise between 3% and 97% by weight of C14, in a reaction container comprising a vacuum inlet, to obtain a first glycerol and fatty acids mixture;
b) heating the first glycerol and fatty acid mixture to at least 140° C. under reduced pressure over a predefined amount of time;
c) keeping the first glycerol and fatty acid mixture at the temperature of step b) for a predefined amount of time, to obtain a second glycerol and fatty acid mixture;
d) heating the second glycerol and fatty acid mixture to at least 180° C. over a predefined amount of time;
e) keeping the second glycerol and fatty acid mixture at the temperature of step d) for a predefined amount of time, to obtain a crude vegetable fat composition;
f) bleaching and filtering the crude vegetable fat composition; and
g) removing unreacted excess free fatty acids from the crude vegetable fat composition by distillation at a temperature of at least 160° C., under reduced pressure, to obtain a final vegetable fat composition comprising triglycerides.

111. A confectionary or chocolate or chocolate-like product comprising between 10 wt. % and 70 wt. % by weight of a vegetable fat composition according to claim 87.
